(19) United States
(12) Patent Application Publication
(10) Pub. No.: US 2011/0110547 A1
(43) Pub. Date: May 12, 2011

(54) Electronic device

(75) Inventors: Takashi Oishi, Tokyo (JP); Yoshihisa Tsuchida, Kanagawa (JP); Kouji Hisamatsu, Saitama (JP)

(73) Assignee: Sony Corporation, Tokyo (JP)

(21) Appl. No.: 12/924,964

(22) Filed: Oct. 8, 2010

(30) Foreign Application Priority Data
Nov. 9, 2009 (JP) P2009-256072

(51) Int. Cl. H04R 1/02

(52) U.S. Cl. 381/332

(57) ABSTRACT

An electronic device includes a speaker element having a diaphragm and a driving unit that vibrates the diaphragm; a mounting unit, in a housing, to which the speaker element is mounted; and an enclosure formed next to the mounting unit. The speaker element is mounted to the mounting unit in the housing while a side of the diaphragm is a side to be mounted to the mounting unit in the housing and a side of the driving unit is opened.

### CROSS-REFERENCE TO RELATED APPLICATION

The present application claims priority from Japanese Patent Application No. JP 2009-256072 filed in the Japanese Patent Office on Nov. 9, 2009, the entire content of which is incorporated herein by reference.

### BACKGROUND OF THE INVENTION

1. Field of the Invention

The present invention relates to an electronic device, such as a still camera or a video camera with a built-in speaker element.

2. Description of the Related Art

As shown in FIG. 7, a small-sized digital still camera 100 has an approximately rectangular camera body 101 that is thinned and small-sized. This camera body 101 is provided with a lens unit 102 at one of upper front corners and is provided with a shutter button 103 on the other side on an upper surface. In the digital still camera 100, a CMOS sensor or a CCD element is used as an imaging element. The digital still camera 100 receives an imaging light, collected by the lens unit 102 at a timing of the shutter button 103 being pressed, with the imaging element and generates image data. In the digital still camera 100, a video image can also be taken, and in this case, it is also possible to record audio by a built-in microphone in addition. When the taken video image data is replayed, a video image is displayed on a display unit on a backside of the camera body 101 and audio is emitted from a built-in speaker element.

The digital still camera 100 generally uses a dynamic speaker for the speaker element. In such a dynamic speaker, a diaphragm is mounted to a bobbin of a voice coil to make a driving unit together with a magnetic circuit unit. Accordingly, power supply to the voice coil is carried out not from the diaphragm side but from the driving unit side via a flexible wiring board, a harness, and the like.

For example, in the digital still camera 100 shown in FIG. 7, sound bores 104 are formed near the shutter button 103 on the upper surface of the camera body 101, and a speaker element 105 is mounted inside the sound bores 104. Specifically, as shown in FIG. 8, the camera body 101 has a front panel 111, a back panel 112, and a middle panel 113 that construct a housing, and they are coupled in such a manner that the front panel 111 and the back panel 112 sandwich the middle panel 113. In a portion of the front panel 111 to make the upper surface of the camera body 101, the sound bores 104 are formed. In the middle panel 113, a mounting recess 114 is formed to mount the speaker element 105 so as to be inserted. In the mounting recess 114, a cylindrical unit 115 is formed that continues to the mounting recess 114 and touches an area surrounding the sound bores 104.

The dynamic speaker emits antiphase sound from both a forward face and a rear face of a diaphragm 105a. In the dynamic speaker, a driving unit 105b formed of a magnetic circuit unit and a voice coil is provided on the rear face side of the diaphragm 105a and a wiring is provided for power supply to the voice coil. Accordingly, the rear face side of the diaphragm has a complex shape and has a structure of not being easily sealed. In a mounting structure of the speaker element 105 shown in FIG. 8, the sealed structure on the rear face side of the diaphragm 105a becomes incomplete. With that, in the mounting structure of the speaker element 105 shown in FIG. 8, by providing the cylindrical unit 115 in the area surrounding the sound bores 104, a sound channel is sealed and prevents cancelling with a sound from the rear face and lowering of the sound pressure.

However, providing the cylindrical unit 115 in a small-sized and thinned electronic device, such as the digital still camera 100 shown in FIG. 7, turns out to interrupt further small-sizing of the entire device. Since the rear face side of the diaphragm 105a is also provided with the driving unit 105b and the wiring of the diaphragm 105a, it is difficult to be provided with the sealed structure of the rear face side of the speaker element 105. Therefore, it turns out to cause lowering of the sound pressure.

Providing the sound bores 104 in the camera body 101 also turns out to limit planning of an appearance, that is, design of the entire digital still camera 100.

Japanese Unexamined Patent Application Publication No. 2007-258198 is an example of related art.

### SUMMARY OF THE INVENTION

It is desirable to provide an electronic device with a built-in speaker element to which a speaker element can be easily mounted and also that can prevent lowering of a sound pressure even when a device body is small-sized.

An electronic device according to an embodiment of the present invention includes a speaker element having a diaphragm and a driving unit that vibrates the diaphragm; a mounting unit, in a housing, to which the speaker element is mounted; and an enclosure formed next to the mounting unit. The speaker element is mounted to the mounting unit in the housing while a side of the diaphragm is a side to be mounted to the mounting unit in the housing and a side of the driving unit is opened.

According to an embodiment of the present invention, a speaker element is mounted to a mounting unit in a housing, where a diaphragm side thereof is a side to be mounted to the mounting unit in the housing and a driving unit side thereof is opened. A general speaker element has an identical height on the outer periphery of the diaphragm. Accordingly, the side of the diaphragm can be easily mounted without providing the enclosure with a gap. Since there is no gap, the sound from the driving unit side is not cancelled by the antiphase sound from the diaphragm side and the lowering of the sound pressure can be prevented.

### BRIEF DESCRIPTION OF THE DRAWINGS

FIG. 1 is a perspective view, taken from the front, of a digital still camera to which an embodiment of the present invention is applied and illustrates a state of a lens cover being open;

FIG. 2 is a plan view of a digital still camera to which the embodiment of the present invention is applied in a state of removing a lens cover;

FIG. 3 is a cross-sectional view of a speaker element;

FIG. 4 is an exploded perspective view of a mounting structure of a speaker;

FIG. 5 is a cross-sectional view of the mounting structure of the speaker;

FIG. 6 is a plan view of the mounting structure of the speaker;

FIG. 7 is a perspective view of a digital still camera of related art; and

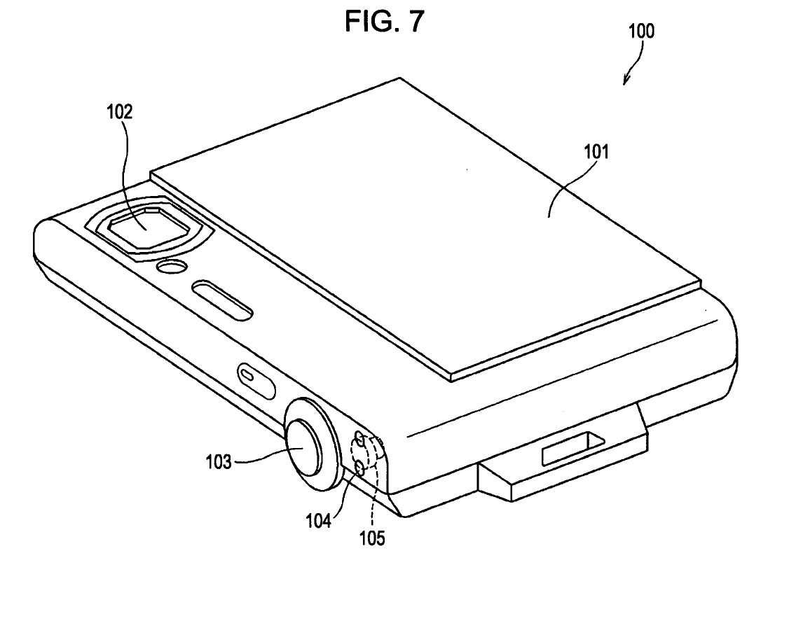

FIG. 8 is a cross-sectional view of a mounting structure of a speaker of related art.

### DESCRIPTION OF THE PREFERRED EMBODIMENTS

A description is given below to a digital still camera 1 to which an electronic device according to an embodiment of the present invention is applied with reference to the drawings. Hereinafter, the digital still camera 1 may also be referred to simply as a camera 1. In the section of the description of the preferred embodiments, a description is given in accordance with the following order to application examples of embodiments of the present invention.
(1) Construction of Digital Still Camera
(2) Description of Speaker Element
(3) Mounting Structure of Speaker Element
(4) Effect of Application to Digital Still Camera
(5) Modifications

### (1) Construction of Digital Still Camera

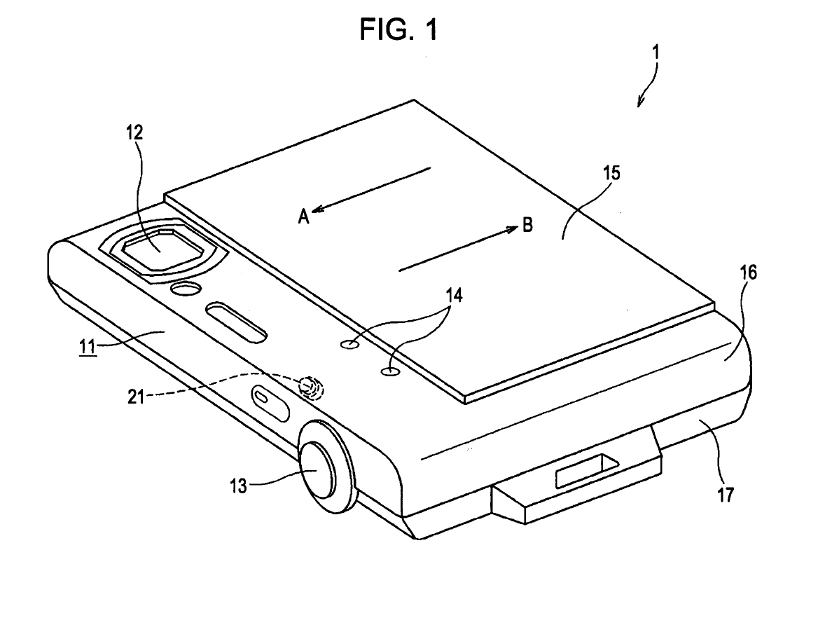

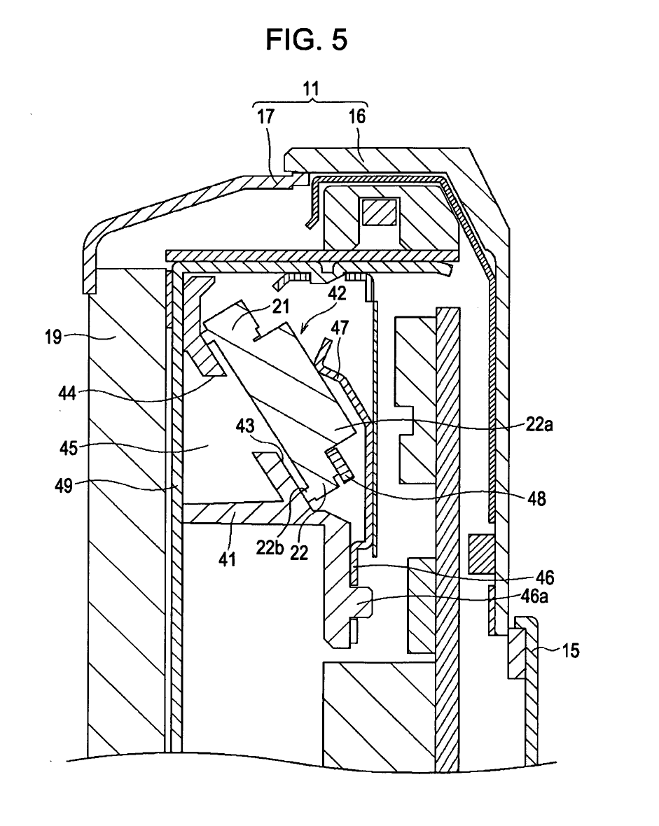

As shown in FIG. 1, the camera 1 to which an embodiment of the present invention is applied has an approximately rectangular camera body 11 that is thinned and small-sized. The camera body 11 is provided with a lens unit 12 at one of upper front corners and a shutter button 13 on the other side of the upper surface. The camera 1 uses a CMOS sensor or a CCD element as an imaging element. The digital still camera 1 receives an imaging light, collected by the lens unit 12 at a timing of the shutter button 13 being pressed, with the imaging element and generates image data. It is also possible to take a video image with the digital still camera 1, and in this case, it is additionally possible to record audio by a built-in stereo microphone 14. When the taken video image data is replayed, a video image is displayed on a display unit 19 (refer to FIG. 5), such as an LCD and an organic electroluminescence device, on a backside of the camera body 11 and the audio is emitted from a built-in speaker element 21.

As shown in FIG. 1, the forward face of the camera body 11 on which the lens unit 12 is provided has a lens cover 15 mounted thereto to open and close the lens unit 12. The lens cover 15 is formed of a flat plate in the size of covering at least half or more of the forward face of the camera body 11 or in the size capable of covering the lens unit 12. The lens cover 15 slides vertically (directions of arrows A and B in FIG. 1) relative to the camera body 11. The lens cover 15 is, when not used, slid in the direction of the arrow A in FIG. 1, blocking the lens unit 12, to block the lens unit 12. The lens cover 15 is, when used, slid in the direction of the arrow B in FIG. 1 to open the lens unit 12 and make it in a state capable of imaging.

As shown in FIGS. 1, 2, and 5, the camera body 11 constructs a housing by coupling a front panel 16 and a back panel 17. The housing has built-in electronic components, such as an imaging element, a primary cell or a secondary cell, a speaker element, a microphone, an electronic flash, a display element (such as an LED and an organic electroluminescence device), a printed circuit board, and an installation device for an external storage medium. The lens cover 15 mentioned above is mounted to the front panel 16.

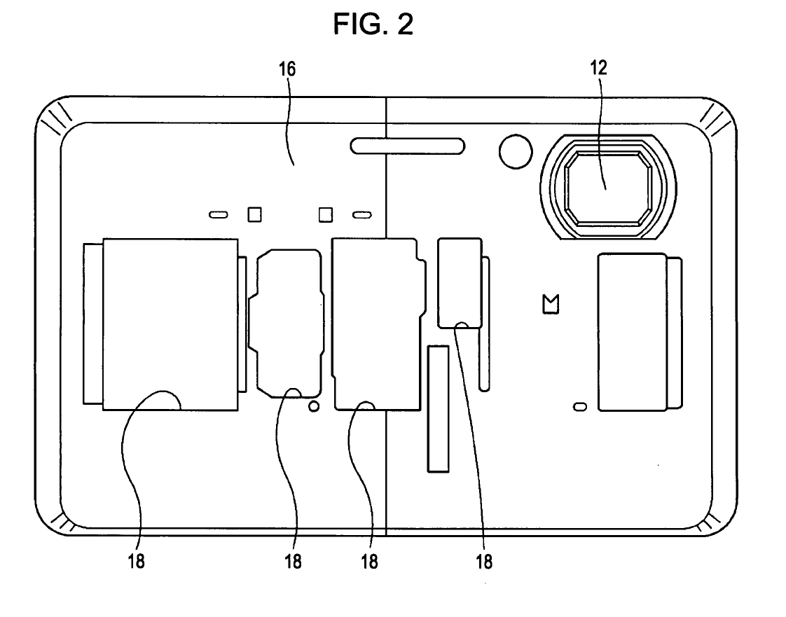

In the front panel 16, as shown in FIG. 2, one or a plurality of openings 18 is formed. The lens cover 15 is mounted slidably via the opening(s) 18 relative to a frame disposed in the housing. Specifically, in the frame in the housing, a guide piece is formed along the directions of moving the lens cover 15. The guide piece faces outside from the opening(s) 18 of the front panel 16. Meanwhile, in a back face of the lens cover 15, a guide groove is formed that is engaged to the guide piece of the frame in the housing. The lens cover 15 slides vertically (the directions of the arrows A and B in FIG. 1) to the camera body 11 by relatively engaging the guide piece on the housing side to the guide groove on the back face of the lens cover 15. The frame in the housing and the back face of the lens cover 15 are linked with an inverting member that inverts a bias direction of a toggle spring or the like. The lens cover 15 is designed to slide by the bias force of the inverting member according to a direction of operation when operated to slide, and thus the operability is improved. The camera body 11 is thinned by providing a sliding mechanism for the lens cover 15 as above at a portion of the opening(s) 18 of the front panel 16.

As described above, the camera body 11 is mounted to the forward face of the lens cover 15, which is a movable component, and a minute void is formed between the front panel 16 and the lens cover 15 for sliding the lens cover 15. In the camera body 11, the inside of the housing is in communication with the outside via the minute void and the opening(s) 18 of the front panel 16. The sound outputted from the speaker element 21 built in the housing is emitted outside the camera body 11 via such a minute void.

### (2) Description of Speaker Element

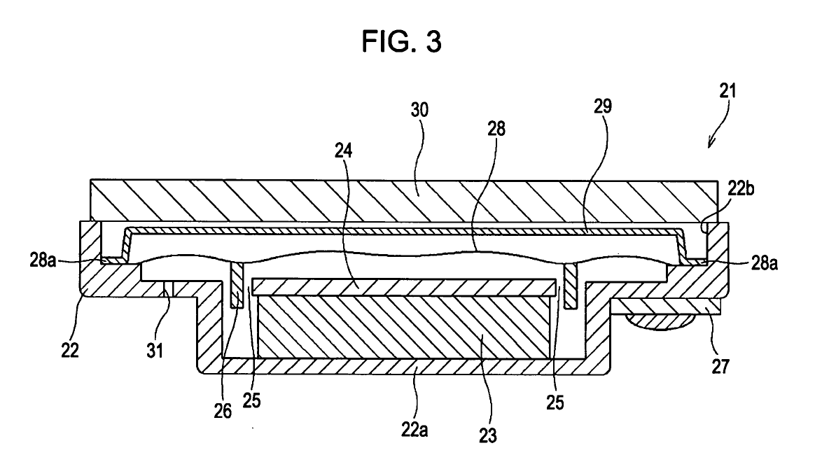

The camera body 11 has a built-in speaker element 21 to emit audio data, replayed in synchronization with operation sound data and video image data, near an approximate center of the upper surface side of the camera body 11 provided with the shutter button 13 and the like. As shown in FIG. 3, the speaker element 21 has a frame 22 formed with a convex cross-section. The frame 22 has a protrusion 22a constructing a space to dispose a driving unit of the speaker element 21. The frame 22 hangs over outwardly in a flange shape so as to continues to the protrusion 22a and has an opening 22b having a larger diameter than the protrusion 22a.

In the protrusion 22a, a magnet 23 is disposed that constructs a magnetic circuit unit and also a top plate 24 is disposed on the magnet 23. The frame 22 and the top plate 24 also become a yoke. A magnetic gap 25 is formed between an outer periphery surface of the top plate 24 and approximately orthogonal corner portions to make a border of the protrusion 22a and the opening 22b. A voice coil 26 is disposed in the magnetic gap 25. On an outer surface at the hanging portion of the frame 22, that is, on a surface of the protrusion 22a side, a terminal 27 is formed. The terminal 27 is electrically connected to an end of the voice coil 26, and further, is electrically connected to terminal units of a driving circuit of an external speaker and a wiring board, such as a flexible wiring board, by solder, a conductive adhesive, or the like.

In the opening 22b of the frame 22, a step 28a is formed in the middle of the height and an outer periphery of a diaphragm 28 is fixed to the step 28a with an adhesive or the like. The middle portion of the diaphragm 28 is fixed to a tip end of the voice coil 26 with an adhesive or the like. Further, a frame cover 29 is fixed to the step 28a so as to cover the opening 22b. Further, a net packing 30 is fixed to an opening end of the opening 22b. The net packing 30 is not strictly desired. In such a manner, the speaker element 21 has an identical height on the opening 22b side of the frame 22.

In the speaker element 21, one or a plurality of sound bores 31 are formed in the portion of the frame 22 hanging over from the protrusion 22a. In the speaker element 21, a driving current corresponding to an inputted audio signal is supplied to the voice coil 26, thereby vibrating the diaphragm 28 to generate a sound. The sound bore(s) 31 enable the sound generated in the diaphragm 28 to be emitted from the protrusion 22a side of the frame 22.

### (3) Mounting Structure of Speaker Element

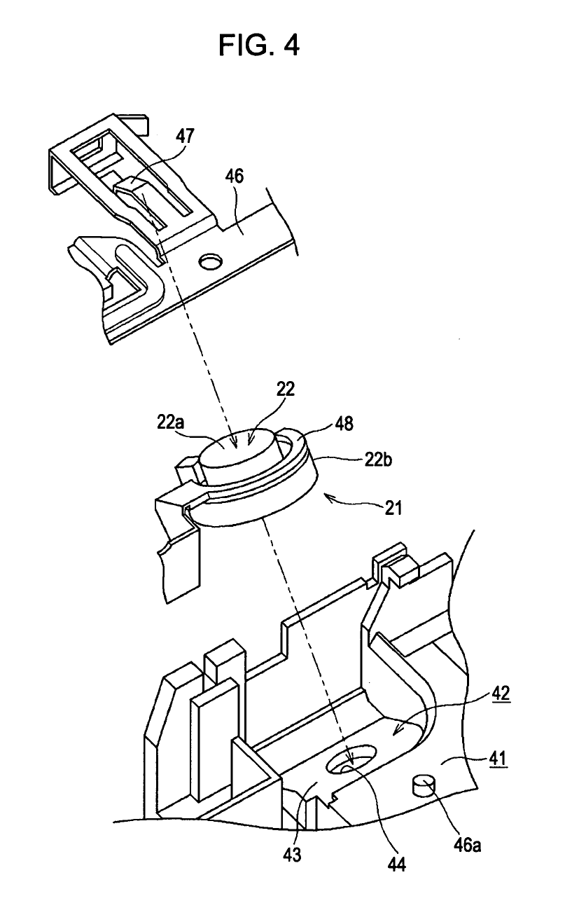

The camera body 11 has a built-in speaker element 21, near the approximate center of the upper surface side of the camera body 11 on which the shutter button 13 and the like are provided, that emits audio data to be replayed in synchronization with the operation sound data and the video image data. As shown in FIGS. 4 through 6, the speaker element 21 has a mounting structure in which a component mounting member 41 of a mold component disposed in the housing constructing the camera body 11 is provided with a mounting unit 42 of the speaker element 21. The mounting unit 42 is a recess having an approximate size of inscribing the speaker element 21 and the speaker element 21 has the opening 22b side disposed on a bottom surface side of the recess. The bottom surface of the mounting unit 42 is a slope 43 and is tilted to face an upper forward face of the camera body 11. In the slope 43, a communication bore 44 is formed that is in communication with an enclosure 45 formed adjacent to a back side of the slope 43. The shape of the mounting unit 42 is not strictly desired to be a recess. In the embodiment of the present invention, the bottom surface of the mounting unit 42 may also be a plane vertical to a side wall, not a slope.

As shown in FIG. 5, the enclosure 45 is formed on the back face of the slope 43 so as to make, for example, an approximate triangular cross section. The enclosure 45 is blocked by a plate member 49 having a bottom surface thereof formed of a sheet metal, a resin plate, and the like. The enclosure 45 here has a content of, for example, approximately 1 cc. Thus, a sealed space is formed in the enclosure 45. In the enclosure 45, the sealed space may also be constructed without using the plate member 49 but only with the component mounting member 41.

The speaker element 21 is disposed in the recess of the mounting unit 42 to have the opening 22b side facing the bottom surface side of the recess. In this case, the space of the mounting unit 42 has the bottom surface as the slope 43 and is formed in an approximate triangular cross section, and the speaker element 21 is arranged obliquely. Accordingly, a space for storing the speaker element 21 can be smaller than a space of a rectangular that is a flattened bottom surface. That is, the speaker element 21 is arranged in a smaller space.

When the speaker element 21 is mounted to the mounting unit 42, the speaker element 21 has the frame 22 side facing upwardly and obliquely. In the speaker element 21, the sound bore(s) 31 are formed in the frame 22 and the generated sound is emitted from the sound bore(s) 31.

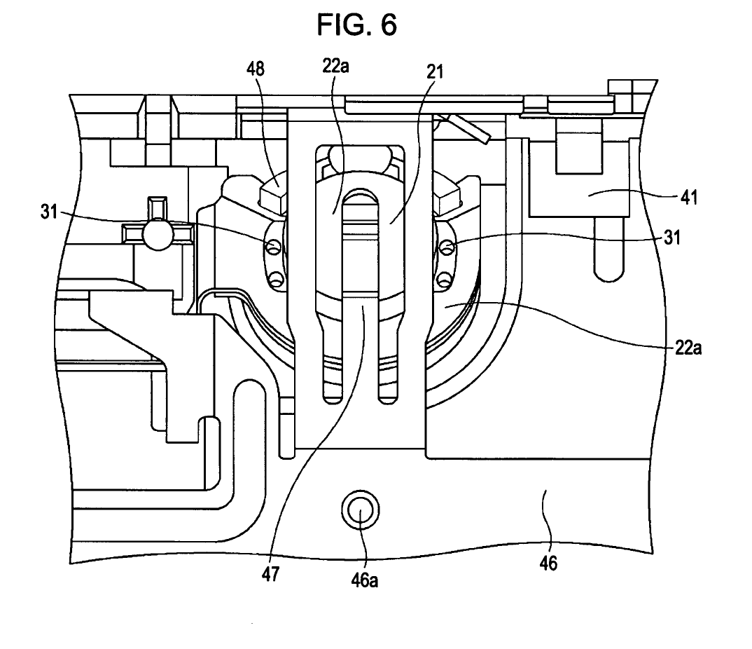

The speaker element 21 mounted to the mounting unit 42, as shown in FIGS. 5 and 6, is subsequently supported elastically by an elastic support piece 47 formed in a support plate 46 to fix various components in the camera body 11. The support plate 46 is formed by punching out a sheet metal, for example. The elastic support piece 47 is formed by punching out an area surrounding the elastic support piece 47 of the support plate 46 and presses the speaker element 21 to the slope 43 for support by an elastic force that is approximately vertical to the slope 43. Thus, the speaker element 21 is fixed to the recess of the mounting unit 42. The support plate 46 is positioned by being engaged to a positioning lug 46a of the component mounting member 41 near the elastic support piece 47.

Further, the speaker element 21 may also be fixed to the slope 43 using an adhesive or the like.

As shown in FIGS. 4 and 6, a flexible wiring board 48 electrically connected to the terminal 27 is disposed along an area surrounding the protrusion 22a on the back face of the frame 22 of the speaker element 21. At this point, the flexible wiring board 48 is mounted so as to avoid the sound bore(s) 31 of the frame 22 not to block the sound bore(s) 31.

In the flexible wiring board 48, in a case of overlapping the sound bore(s) 31 when disposed along the area surrounding the protrusion 22a, a notch or a through hole turns out to be formed to expose the sound bore(s) 31 to the outside.

In the mounting structure of the speaker element 21 shown in FIGS. 4 through 6, a space of an approximate cube or an approximate rectangular parallelepiped is sectioned by the slope 43 into two in an approximate triangular cross section shape. Accordingly, this mounting structure is capable of defining one as the mounting unit 42 to mount the speaker element 21 and the other as the enclosure 45 for a space-saving speaker system.

The speaker element 21 is mounted in such a manner that the opening 22b of the frame 22 on the diaphragm 28 side is pressure contacted to the slope 43. The speaker element 21 has the diaphragm 28 side, that is, the opening 22b formed in an identical height and having a shape simpler than that of the protrusion 22a side. Accordingly, the speaker element 21 can be mounted easily to the slope 43 as the shape of the opening 22b is simple. Since the speaker element 21 is easily attached firmly to the flattened slope 43 without a gap, the opening 22b side and the protrusion 22a side can be separated securely with the diaphragm 28 as a border. Accordingly, in this speaker system, the degree of sealing the space on the enclosure 45 side becomes high. Accordingly, the sound emitted from the frame 22 side of the speaker element 21 is emitted from the sound bore(s) 31 of the frame 22 to the outside, that is, into the camera body 11 without being cancelled by an antiphase sound on the opening 22b side, that is, without causing lowering of the sound pressure.

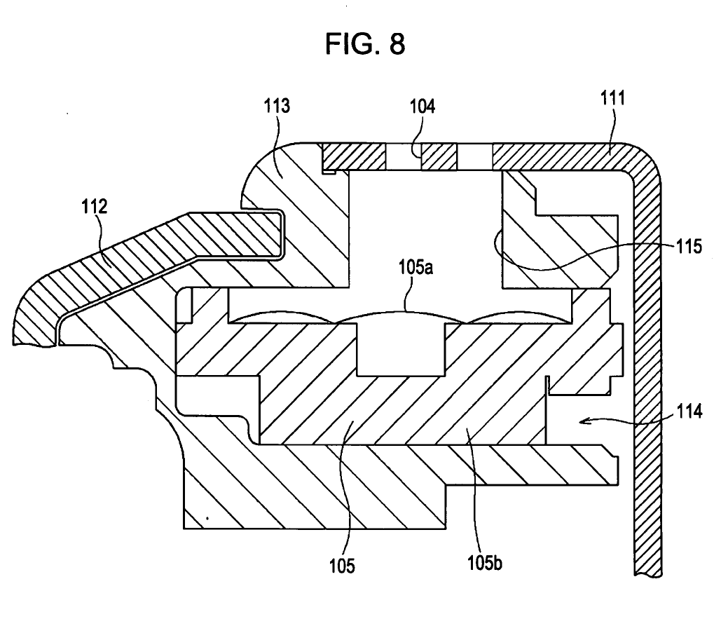

Results of comparative experiments is shown below regarding sound pressures in the mounting structure of the speaker element to which the embodiment of the present invention shown in FIGS. 4 through 6 is applied (the embodiment of the present invention) and the mounting structure of the speaker element shown in FIG. 8 (a related art structure 1, a related art structure 2). The embodiment of the present invention has a speaker element with a diameter of 8 φ, which is smaller than those of the related art structures 1 and 2 of 10 φ.

| | 600 Hz | 1 kHz | 3 kHz |
|---|---|---|---|
| Related art structure 1 | 30.5 dB | 52.0 dB | 63.5 dB |
| Related art structure 2 | 32.0 dB | 53.0 dB | 63.5 dB |
| Embodiment of present invention | 31.5 dB | 50.5 dB | 62.0 dB |

From the results above, it is possible to confirm that the mounting structure of the speaker element to which the embodiment of the present invention shown in FIGS. 4 through 6 is applied can have a sound pressure level of a similar degree to that of the related art structures 1 and 2 even when the diameter of the speaker element is smaller.

In the embodiment of the present invention, the direction to mount the speaker element 21 to the slope 43 is not limited to the case of facing the upper forward face of the camera body 11 and it may also face, for example, a lower forward face of the camera body 11 or further another direction.

### (4) Effect of Application to Digital Still Camera

As shown in FIGS. 1 and 2, the lens cover 15, which is a movable component, is mounted to the forward face of the camera body 11. Between the front panel 16 and the lens cover 15, a minute void for sliding the lens cover 15 is formed. In the camera body 11, the inside of the housing and the outside are in communication via the minute void and the opening(s) 18 of the front panel 16. The sound emitted from the sound bore(s) 31 of the speaker element 21 built in the housing is emitted outside the camera body 11 via the opening(s) 18 or the minute void between the lens cover 15 and the front panel 16. The sound bore(s) 31 formed in the frame 22 of the speaker element 21 faces the forward face side of the camera body 11 to which the lens cover 15 is mounted. Accordingly, the sound emitted from the sound bore(s) 31 is efficiently emitted outside the camera body 11 via the opening(s) 18 and the minute void between the lens cover 15 and the front panel 16.

As described above, the sound emitted by the speaker element 21 is emitted outside the camera body 11 mainly via the opening(s) 18 and the minute void between the lens cover 15 and the front panel 16. Other than that, the sound emitted by the speaker element 21 is emitted outside the camera 1 also from a minute void formed in a portion of coupling the front panel 16 and the back panel 17 and the like.

In such a manner, in the camera 1, the sound from the speaker element 21 is emitted via the minute voids created for mounting the lens cover 15, which is a movable component. Accordingly, the camera 1 is provided without the sound bores 104 provided in the camera body 101, as in the digital still camera 100 of related art, and can enhance the flexible planning of design.

### (5) Modifications

Although the description is given above to an example of the digital still camera 1 to which the embodiment of the present invention is applied, an electronic device using a mounting structure of the speaker element 21 to which the embodiment of the present invention is applied may also be another imaging device, such as a compact video camera. It may also be an information processing device, such as a compact personal computer.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device, comprising:
a speaker element having a diaphragm and a driving unit that vibrates the diaphragm;
a mounting unit, in a housing, to which the speaker element is mounted; and
an enclosure formed next to the mounting unit;
wherein the speaker element is mounted to the mounting unit in the housing while a side of the diaphragm is a side to be mounted to the mounting unit in the housing and a side of the driving unit is opened.

2. The electronic device according to claim 1, wherein a movable component is mounted to the housing.

3. The electronic device according to claim 2, wherein
the speaker element has a frame covering the driving unit,
a sound bore is formed in the frame, and
a wiring board for power supply to the driving unit is mounted to the frame so as to avoid the sound bore.

4. The electronic device according to claim 3, wherein a communication bore to the enclosure is formed on a mounting surface of the mounting unit adjacent to the enclosure.

5. The electronic device according to claim 4, wherein the mounting surface of the mounting unit is a slope.

6. The electronic device according to claim 4, wherein the speaker element is pressed and supported on the mounting surface of the mounting unit by an elastic support piece formed in a support plate that supports components in the housing.
